(19) United States
(12) Patent Application Publication
(10) Pub. No.: US 2026/0054419 A1
(43) Pub. Date: Feb. 26, 2026

(54) CLAMPING DEVICE FOR SINTERED STONE CUTTING MACHINE

(71) Applicant: Hui-Chuan LIAO, Oakland, CA (US)

(72) Inventor: Hui-Chuan LIAO, Oakland, CA (US)

(21) Appl. No.: 18/814,268

(22) Filed: Aug. 23, 2024

(51) Int. Cl. B28D 7/04

(52) U.S. Cl. CPC B28D 7/04

(57) ABSTRACT

A clamping device for a sintered stone cutting machine is disposed on a sintered stone cutting machine and has a clamping mount and a pressing rod. The sintered stone cutting machine has a track base and a cutter. The clamping device is disposed on the track base at an end of the track base. The clamping mount clamps two sides of the track base and has a base portion and two clamping arms. The two clamping arms are formed on and protruded from the base portion and respectively clamp the two sides of the track base. The pressing rod is rotatably connected to the base portion of the clamping mount to move toward or away from a bottom of the track base.

### BACKGROUND OF THE INVENTION

### 1. Field of the Invention

The present invention relates to a clamping device, and more particularly to a clamping device for a sintered stone cutting machine that is securely clamped and accurate for cutting.

### 2. Description of Related Art

Building materials such as glass, tiles, and sintered stones often need to be cut into corresponding shapes and sizes according to users' needs. Among them, sintered stone is a high-hardness plate made of natural materials through vacuum extrusion and high-temperature sintering, and has characteristics of anti-wear, scratch resistance, high temperature resistance, and environmental protection, etc. Therefore, sintered stones are commonly used in the fields of construction, decoration, furniture, etc. Since the sintered stones are high-hardness slabs, the requirements for cutting accuracy and stability are higher than those of glass and tiles, so they cannot be used with ordinary cutting machines and need to be matched with a sintered stone cutting machine.

A conventional sintered stone cutting machine has a track base, a cutter, and multiple suckers. The track base is elongated. The cutter is movably disposed on the track base and has an operating shaft and a cutting wheel. The operating shaft is swingably disposed on the cutter and is located on one side of the track base. The cutting wheel is located below the cutter and is connected to the operating shaft. Then the cutting wheel can be moved relative to the track base by the operating shaft. The multiple suckers are connected to the track base and are located on the other side of the track base. When the conventional sintered stone cutting machine is in use, the track base is disposed on a top of a processed sintered stone and is moved relative to the processed sintered stone according to a cutting location. After moved to the cutting location, the track base can be held securely on the processed sintered stone by the multiple suckers adsorbed to the top of the processed sintered stone. Then a user can hold and swing the operating shaft to move the cutting wheel toward the processed sintered stone, as the operating shaft moves, the cutting wheel abuts against the processed sintered stone. With the movement of the operating shaft relative to the track base, the cutting wheel forms a cutting line on the processed sintered stone, and the operation of the conventional sintered stone cutting machine is completed.

However, the conventional sintered stone cutting machine can provide a cutting effect to the processed sintered stone and can be easily assembled and disassembled on the processed sintered stone by the multiple suckers. After long-term use, the materials of the multiple suckers are easily affected by material changes, which affects the adsorption strength and stability of the multiple suckers to the processed sintered stone. Then the track base cannot be stably held on the processed sintered stone, and this will affect the accuracy of the subsequent cutting of the conventional sintered stone cutting machine to the processed sintered stone. The conventional sintered stone cutting machine has the above-mentioned problems and deficiencies and needs improvement.

The clamping device for a sintered stone cutting machine in accordance with the present invention mitigates or obviates the aforementioned problems.

### SUMMARY OF THE INVENTION

The main objective of the present invention is to provide a clamping device for a sintered stone cutting machine that is securely clamped and accurate for cutting.

The clamping device for a sintered stone cutting machine in accordance with the present invention is disposed on a sintered stone cutting machine and has a clamping mount and a pressing rod. The sintered stone cutting machine has a track base and a cutter. The clamping device is disposed on the track base at an end of the track base. The clamping mount clamps two sides of the track base and has a base portion and two clamping arms. The two clamping arms are formed on and protruded from the base portion and respectively clamp the two sides of the track base. The pressing rod is rotatably connected to the base portion of the clamping mount to move toward or away from a bottom of the track base.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a clamping device for a sintered stone cutting machine in accordance with the present invention;

FIG. 2 is another perspective view of the clamping device for a sintered stone cutting machine in FIG. 1;

FIG. 3 is an exploded perspective view of the clamping device for a sintered stone cutting machine in FIG. 1;

FIG. 4 is a side view of the clamping device for a sintered stone cutting machine in FIG. 1;

FIG. 5 is a perspective view of the clamping device for a sintered stone cutting machine in FIG. 1, mounted on a sintered stone cutting machine;

FIG. 6 is an enlarged perspective view of the clamping device for a sintered stone cutting machine in FIG. 5;

FIG. 7 is a side view in partial section of the clamping device for a sintered stone cutting machine in FIG. 6;

FIG. 8 is an operational perspective view of the clamping device for a sintered stone cutting machine in FIG. 5, mounted on a processed sintered stone;

FIG. 9 is an enlarged and operational perspective view of the clamping device for a sintered stone cutting machine in FIG. 8; and

FIG. 10 is an enlarged and operational side view in partial section of the clamping device for a sintered stone cutting machine in FIG. 9.

### DETAILED DESCRIPTION OF THE PREFERRED EMBODIMENT

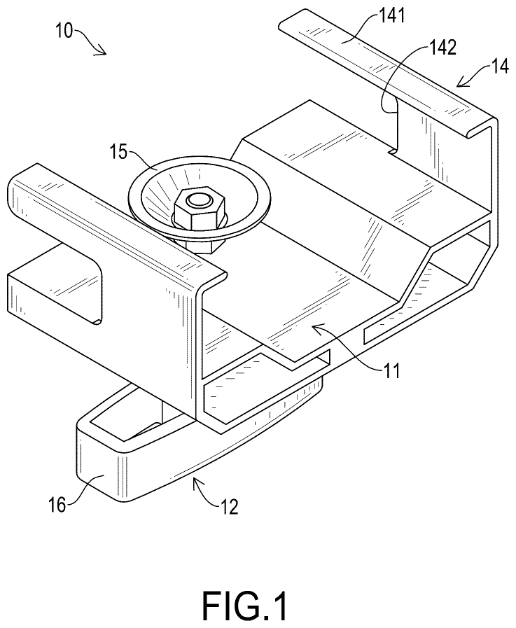

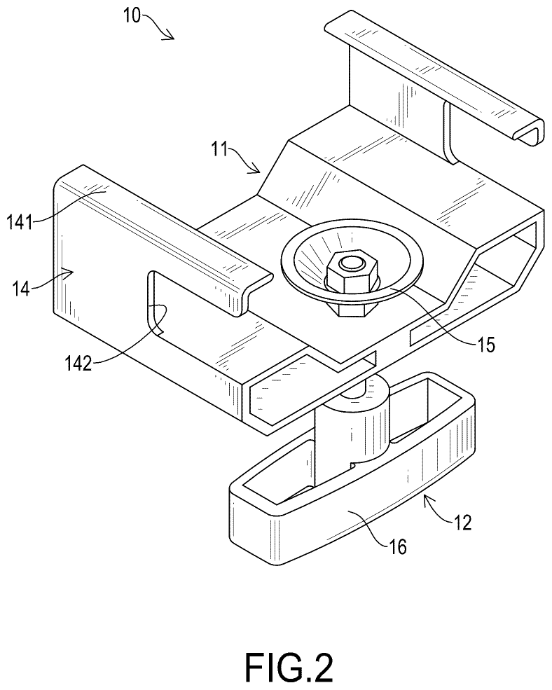

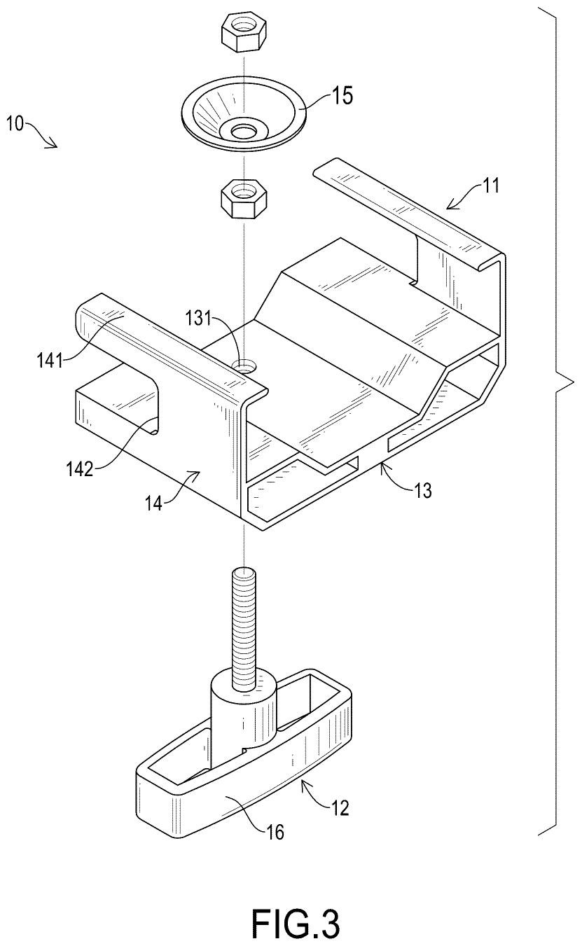

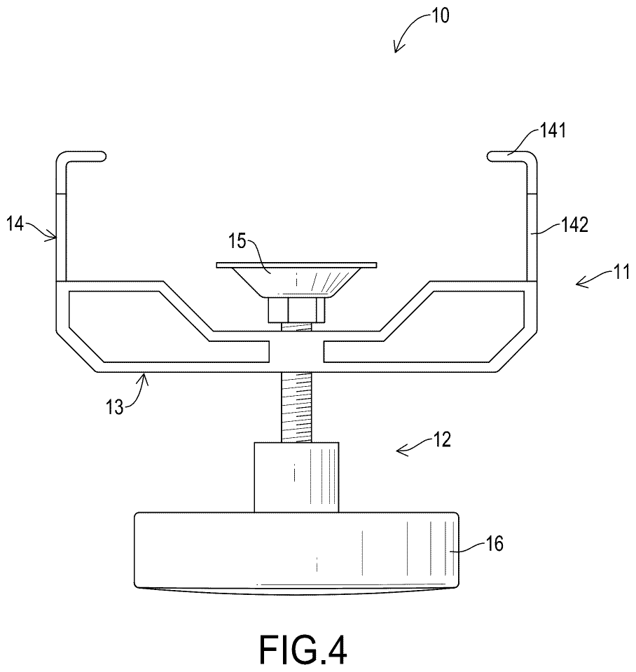

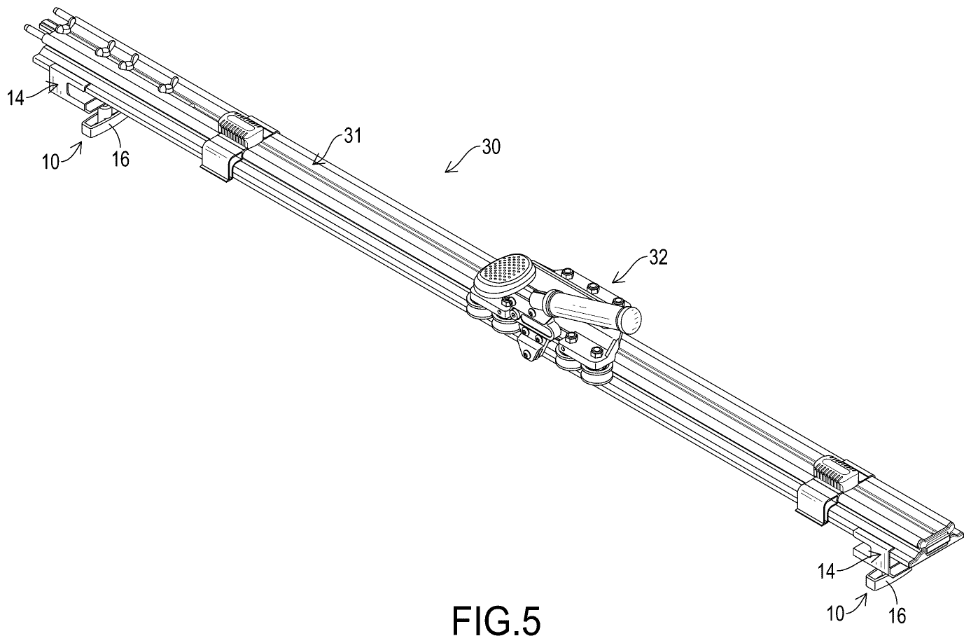

With reference to FIGS. 1 to 5, a clamping device 10 for a sintered stone cutting machine in accordance with the present invention is disposed on a sintered stone cutting machine 30. The sintered stone cutting machine 30 has a track base 31 and a cutter 32. The clamping device 10 is disposed on an end of the track base 31 and has a clamping mount 11 and a pressing rod 12.

The clamping mount 11 has a base portion 13 and two clamping arms 14. The base portion 13 has a connecting hole 131 longitudinally formed through the base portion 13 to face a bottom of the track base 31.

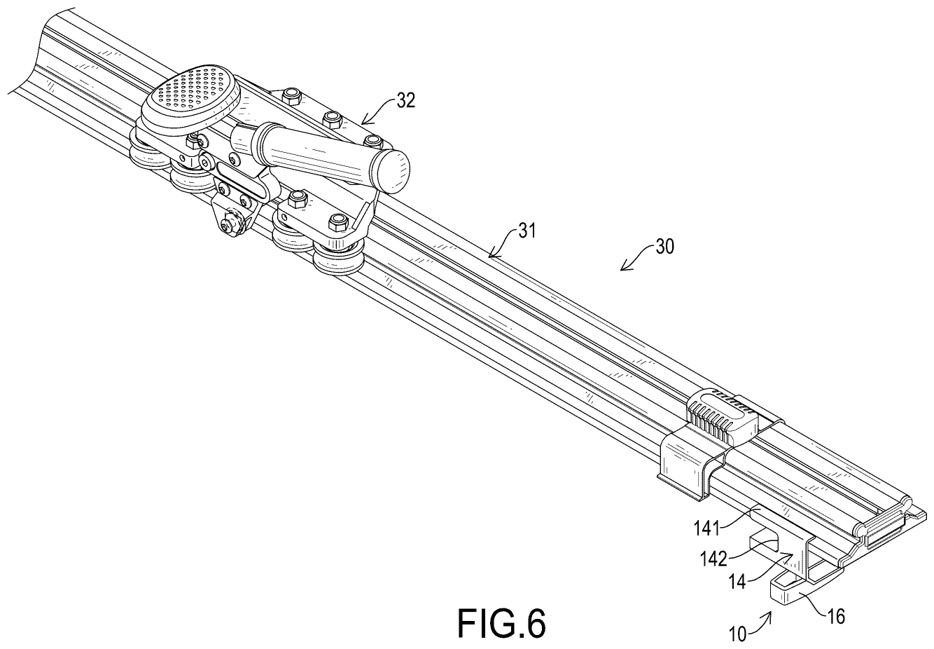

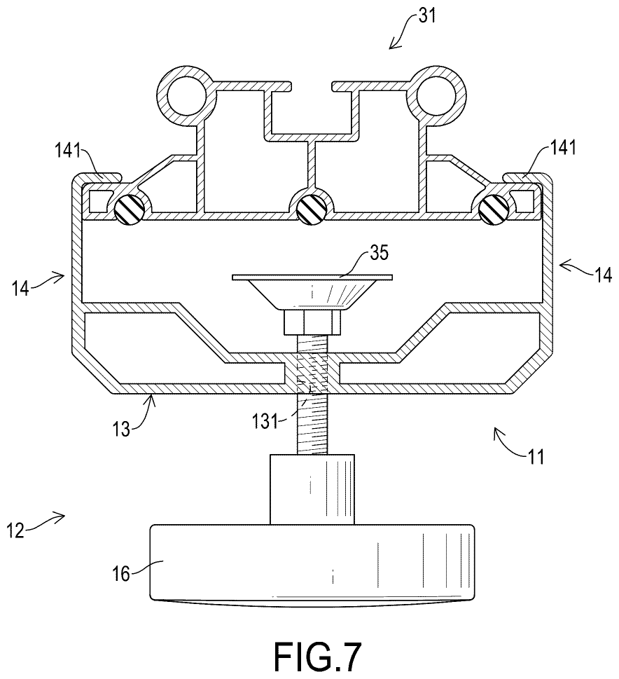

The two clamping arms 14 are formed on and protruded upwardly from a top of the base portion 13, are respectively located at two sides of the base portion 13, and are respectively connected to two sides of the track base 31. Each one of the two clamping arms 14 has a hook portion 141 and an avoidance slot 142. The hook portion 141 is formed on a free end of the clamping arm 14 away from the base portion 13 and engages with one of the two sides of the track base 31. Then, with reference to FIGS. 6 and 7, the clamping mount 11 is connected to the track base 31 by the hook portions 141 of the two clamping arms 14 respectively engaging with the two sides of the track base 31. The avoidance slot 142 is formed in a side of the clamping arm 14 facing the track base 31 between the hook portion 141 and the base portion 13.

The pressing rod 12 is rotatably connected to the base portion 13 of the clamping mount 11 to move toward or away from the bottom of the track base 31, and has a top end, a bottom end, a pushing disk 15, and a rotating handle 16. The top end of the pressing rod 12 extends above the top of the base portion 13 between the two clamping arms 14 via the connecting hole 131, and the pushing disk 15 is disposed on the top end of the pressing rod 12. The bottom end of the pressing rod 12 is disposed below the base portion 13, and the rotating handle 16 is disposed on the bottom end of the pressing rod 12. When the rotating handle 16 is rotated by a user, the pressing rod 12 is rotated relative to the base portion 13, and a distance between the pushing disk 15 and the bottom of the track base 31 can be changed and adjusted.

Additionally, the connecting hole 131 has an inner thread, and the pressing rod 12 has an outer thread formed on an external surface of the pressing rod 12 to screw with the inner thread of the connecting hole 131. Furthermore, the clamping mount 11 is provided across the track base with a spaced interval therebetween, which not only allows the base portion 11 of each clamping mount 11 to be elastic, but also reduces cost of manufacture, and can greatly reduce the overall weight of the clamping device 10 for a sintered stone cutting machine of the present invention, allowing users to transport and store it conveniently.

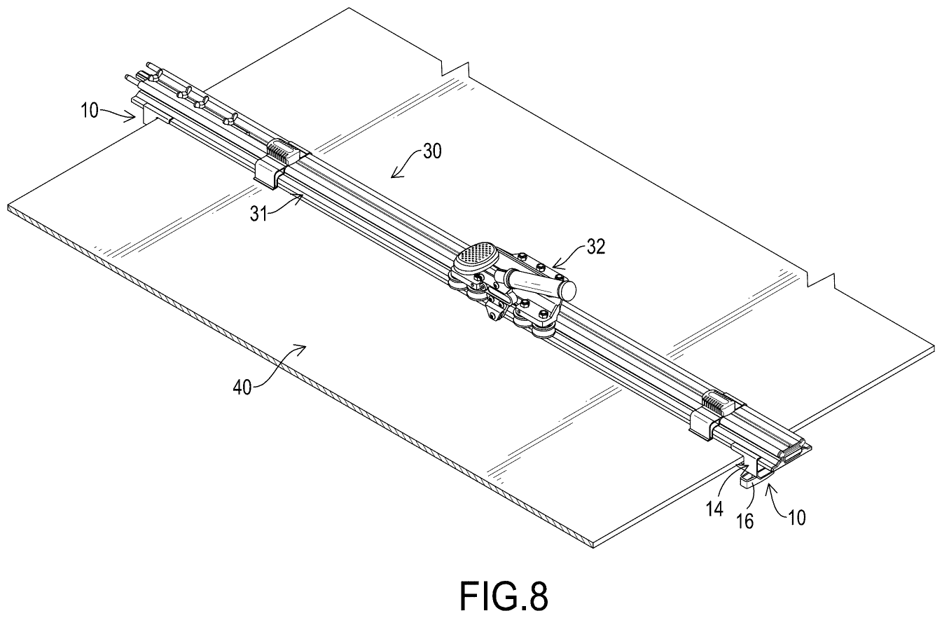

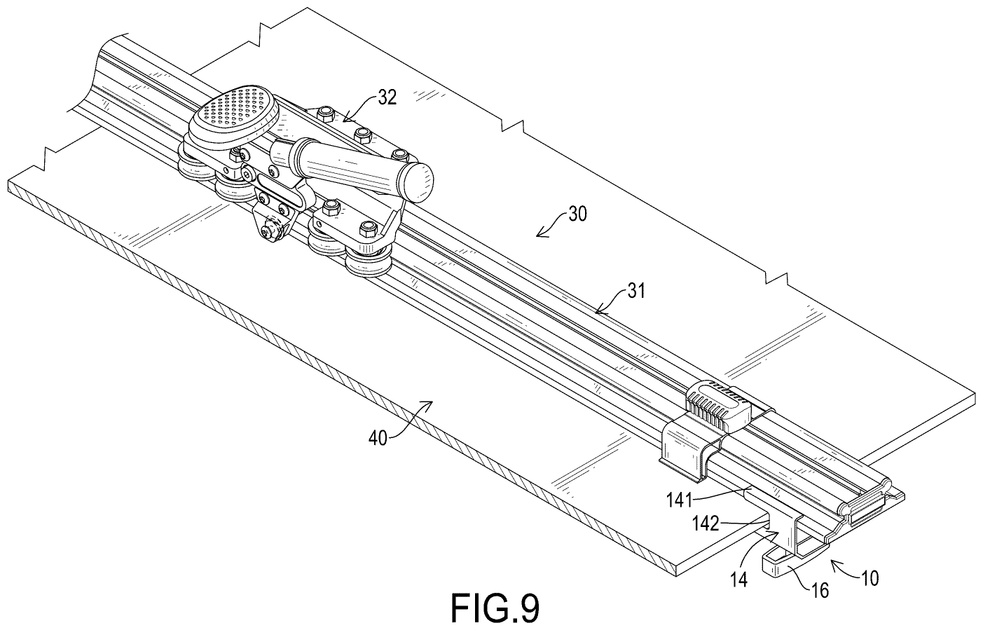

With reference to FIGS. 8 and 9, when the clamping device 10 for a sintered stone cutting machine of the present invention is in use, firstly, the track base 31 is disposed on a processed sintered stone 40, there are two said clamping devices 10 respectively disposed on the two ends of the track base 31. The avoidance slot 142 of the clamping arm 14 of each clamping mount 11 enables the corresponding clamping arm 14 to mount on the processed sintered stone 40, and the processed sintered stone 40 is placed between the track base 31 and the pushing disk 15 of the pressing rod 12 of each clamping device 10.

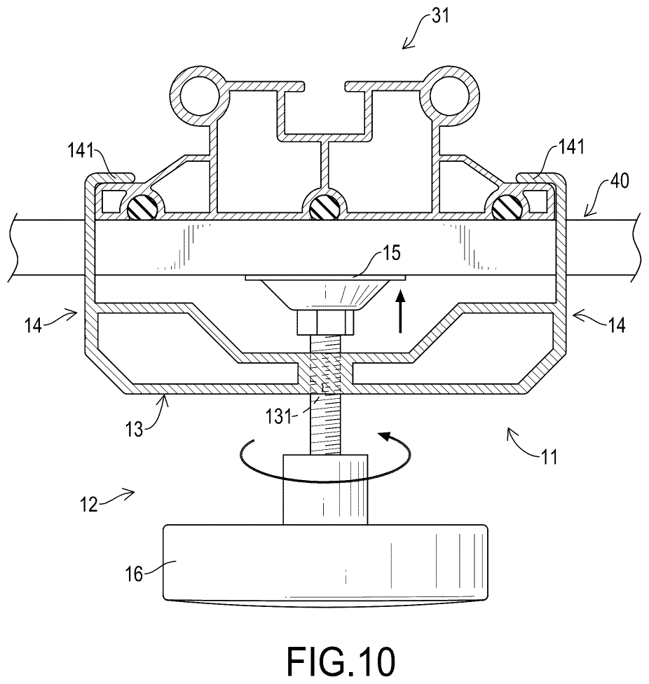

At this time, with reference to FIG. 10, the user can rotate the rotating handle 16 of the pressing rod 12 of each clamping device 10 to move the pressing rod 12 to move toward the track base 31 and to enable the pushing disk 15 to abut against the bottom face of the processed sintered stone 40. Then the track base 31 can be held securely and firmly on the processed sintered stone 40 by the pushing disk 15 of each clamping device 10 upwardly pushing the bottom face of the processed sintered stone 40 and the two clamping arms 14 of each clamping device 10 downwardly clamping the track base 31. Then the user can hold the cutter 32 to move relative to the track base 31 to cut the processed sintered stone 40. After the above operations, the processed sintered stone 40 can be cut to an accurate size.

According to the above-mentioned structural relationships and features of the clamping device 10 for a sintered stone cutting machine of the present invention, in use, the track base 31 can be firmly clamped and disposed on the processed sintered stone 40 by the clamping arms 14 and the pressing rods 12 of the two clamping devices 10. The subsequent cutting process will not affect the accuracy of cutting due to the offset of the track base 31. Therefore, the present invention provides a clamping device 10 for a sintered stone cutting machine that is securely clamped and accurate for cutting.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A clamping device for a sintered stone cutting machine, the clamping device configured to dispose on a sintered stone cutting machine having a track base and a cutter, the clamping device disposed at an end of the track base and comprising:
a clamping mount configured to clamp two sides of the track base; and
a pressing rod rotatably connected to the clamping mount to move toward or away from a bottom of the track base.

2. The clamping device for a sintered stone cutting machine as claimed in claim 1, wherein the clamping mount has
a base portion; and
two clamping arms formed on and protruded upwardly from a top of the base portion, respectively located at two sides of the base portion to respectively connect to the two sides of the track base, and each one of the two clamping arms having
a hook portion formed on a free end of the clamping arm away from the base portion to engage with one of the two sides of the track base; and
an avoidance slot formed in a side of the clamping arm facing the track base between the hook portion and the base portion.

3. The clamping device for a sintered stone cutting machine as claimed in claim 2, wherein
the base portion has a connecting hole formed therethrough; and
a top end of the pressing rod extends above the top of the base portion between the two clamping arms via the connecting hole; and
the pressing rod is rotatably connected to the base portion of the clamping mount and has
a pushing disk disposed on the top end of the pressing rod; and
a rotating handle disposed on a bottom end of the pressing rod.

4. The clamping device for a sintered stone cutting machine as claimed in claim 3, wherein
the connecting hole has an inner thread; and
the pressing rod has an outer thread formed on an external surface of the pressing rod to screw with the inner thread of the connecting hole.

5. The clamping device for a sintered stone cutting machine as claimed in claim 2, wherein the clamping mount is provided across the track base with a spaced interval therebetween to allow the base portion to be elastic.

6. The clamping device for a sintered stone cutting machine as claimed in claim 3, wherein the clamping mount is provided across the track base with a spaced interval therebetween to allow the base portion to be elastic.

7. The clamping device for a sintered stone cutting machine as claimed in claim 4, wherein the clamping mount is provided across the track base with a spaced interval therebetween to allow the base portion to be elastic.

8. The clamping device for a sintered stone cutting machine as claimed in claim 1, wherein the clamping mount is provided across the track base with a spaced interval therebetween to allow the clamping base to be elastic.
